(19) United States
(12) Patent Application Publication
(10) Pub. No.: US 2017/0302904 A1
(43) Pub. Date: Oct. 19, 2017

(54) INPUT/OUTPUT DEVICE, INPUT/OUTPUT PROGRAM, AND INPUT/OUTPUT METHOD

(71) Applicant: MIRAMA SERVICE INC., New Castle (DE)

(72) Inventor: Johannes Lundberg, Minato-ku, Tokyo (JP)

(21) Appl. No.: 15/515,632

(22) PCT Filed: Sep. 30, 2014
(86) PCT No.: PCT/JP2014/005003

§ 371 Date: Mar. 30, 2017

(51) Int. Cl. H04N 13/00; H04N 13/04; H04N 5/33; H04N 13/02

(52) U.S. Cl. CPC H04N 13/0022; H04N 13/044; H04N 5/33; H04N 13/0239

(57) ABSTRACT

An object of the present invention is to provide an I/O device, an I/O program, and an I/O method that can use a stereoscopic image for a long time. Another object of the present invention is to provide an I/O device, an I/O program, and an I/O method that can perform an operation even when there is a restriction on the operation due to an object. A display device can generate a stereoscopic image, a depth level sensor measures a distance to an object, and a control section displays a view on the display device according to the depth level sensor. A depth level adjustment mechanism adjusts at least one of a region width and a region position of a measurement region of the depth level sensor.

### TECHNICAL FIELD

The present invention relates to an I/O device, an I/O program, and an I/O method. More specifically, the present invention relates to an I/O device, an I/O program, and an I/O method that can use a stereoscopic image for a long time.

### BACKGROUND ART

Japanese Patent Publication No. 8-31140 (Patent Literature 1) discloses computer graphics, that is, a high-speed image generation/display method in which a vivid and realistic image is displayed on a screen at a high speed.

The high-speed image generation/display method according to Patent Literature 1 is a high-speed image generation/display method in which a target having a three-dimensional structure is projected and displayed on a two-dimensional screen. In this method, a constituent surface of the target is hierarchically described with the region size being defined as at least one element, in a target coordinate system. Then, when the constituent surface of the target taken from an arbitrary point of view is projected on the two-dimensional screen, the hierarchy level is set with the distance from the origin of a display reference coordinate system or the point of view to an arbitrary point of the target represented in the target coordinate system being defined as at least one parameter.

Japanese Patent Laid-Open No. 2004-126902 (Patent Literature 2) discloses a stereoscopic image generation method and a stereoscopic image generation device that efficiently generate a stereoscopic image with no load on an observer.

In the stereoscopic image generation method according to Patent Literature 2, object data to be planarly displayed, of objects each formed by a polygon having three-dimensional coordinates, is converted into reference camera coordinate system data whose origin is a reference camera, and object data to be stereoscopically displayed, of the objects, is converted into pieces of right-eye and left-eye parallax camera coordinate system data whose origins are respectively right-eye and left-eye parallax cameras having a predetermined parallactic angle therebetween. Then, the object data in the reference camera coordinate system and the object data in the right-eye parallax camera coordinate system are drawn as right-eye image data in a video memory, and the object data in the reference camera coordinate system and the object data in the left-eye parallax camera coordinate system are drawn as left-eye image data in the video memory. Then, the right-eye image data and the left-eye image data drawn in the video memory are composited with each other, and an image mixedly including the stereoscopic object and the planar object is displayed on a stereoscopic display device.

National Publication of International Patent Application No. 2012-533120 (Patent Literature 3) discloses a method using face recognition and gesture/body posture recognition techniques.

The method according to Patent Literature 3 is a method for applying attributes indicative of a user's temperament to a visual representation, the method including: rendering the visual representation of a user; receiving data of a physical space, the data being representative of the user in the physical space; analyzing at least one detectable characteristic to deduct the user's temperament; and applying the attributes indicative of the user's temperament to the visual representation.

National Publication of International Patent Application No. 2012-528405 (Patent Literature 4) discloses a system and a method of supplying multi-mode input to a space or gesture calculation system.

The system according to Patent Literature 4 is a system including: an input device; and a detector that is coupled to a processor and detects an orientation of the input device. The input device has a plurality of mode orientations corresponding to the orientation. The plurality of mode orientations correspond to a plurality of input modes of a gesture control system. The detector is coupled to the gesture control system, and automatically controls selection of an input mode of the plurality of input modes in response to the orientation.

National Publication of International Patent Application No. 2012-521039 (Patent Literature 5) discloses a system, a method, and a computer-readable medium for manipulating a virtual object. The method disclosed in Patent Literature 5 is a method of manipulating a virtual object in a virtual space, including: determining at least one controller that a user utilizes to manipulate the virtual object; mapping the controller to a cursor in the virtual space; determining controller input indicative of the user manipulating the virtual object with the cursor; and displaying a result of the manipulation.

Japanese Patent Laid-Open No. 2012-106005 (Patent Literature 6) discloses an image display device, a game program, and a game control method that enables an observer of the image display device to feel as if the observer could directly manipulate an actually non-existing stereoscopic image. The image display device according to Patent Literature 6 includes: image display means for displaying a parallax image on a display screen; first coordinate calculation means for calculating virtual space coordinates of a stereoscopic image that the observer of the parallax image recognizes between the display screen and the observer; second coordinate calculation means for calculating space coordinates of a manipulation object as a manipulation target of the observer; and event generation means for generating a predetermined event that changes at least one of the parallax image and an image on the display screen other than the parallax image, when a distance between the space coordinates of at least one point of the stereoscopic image calculated by the first coordinate calculation means and the space coordinates of at least one point of the manipulation object calculated by the second coordinate calculation means is equal to or less than a predetermined threshold.

International Publication No. WO 2014/106823 (Patent Literature 7) discloses a head-mounted display including a depth level sensor.

In the head-mounted display, instructions for yoga or a game simulator is disclosed.

### CITATION LIST

### Patent Literature

[Patent Literature 1] Japanese Patent Publication No. 8-31140
[Patent Literature 2] Japanese Patent Laid-Open No. 2004-126902
[Patent Literature 3] National Publication of International Patent Application No. 2012-533120
[Patent Literature 4] National Publication of International Patent Application No. 2012-528405
[Patent Literature 5] National Publication of International Patent Application No. 2012-521039
[Patent Literature 6] Japanese Patent Laid-Open No. 2012-106005
[Patent Literature 7] international Publication No. WO 2014/106823

### SUMMARY OF INVENTION

### Technical Problem

An object of the present invention is to provide an I/O device, an I/O program, and an I/O method that can use a stereoscopic image for a long time.

Another object of the present invention is to provide an I/O device, an I/O program, and an I/O method that can perform an operation even when there is a restriction on the operation due to an object.

### Solution to Problem

(1)

An I/O device according to one aspect includes: a display device that can generate a stereoscopic image; a depth level sensor that measures a distance to an object; a control section that displays a view on the display device according to the depth level sensor; and a depth level adjustment mechanism that adjusts at least one of a region width and a region position of a measurement region of the depth level sensor.

In the present invention, the display device can generate the stereoscopic image, the depth level sensor measures the distance to the object, and the control section displays the view on the display device according to the depth level sensor. The depth level adjustment mechanism adjusts at least one of the region width and the region position of the measurement region of the depth level sensor.

In this case, the depth level adjustment mechanism can adjust at least one of the region width and the region position of the measurement region of the depth level sensor. Therefore, the depth level adjustment mechanism can adjust the region width to adjust the region to a large width or the region to a small width. Furthermore, the depth level adjustment mechanism can adjust the region position to a vertically upper region position, a vertically lower region position, a horizontally left region position, and a horizontally right region position.

(2)

With regard to an I/O device according to a second invention, in the I/O device according to the one aspect, the depth level adjustment mechanism may make an adjustment to provide the measurement region below a horizontal plane.

In this case, the depth level adjustment mechanism can provide the measurement region below the horizontal plane. More specifically, since the depth level adjustment mechanism can provide the measurement region below the horizontal plane, the depth level sensor can measure a hand that is the object, and a view can be displayed on the display device even when the hand is on or near the knee in the operation or when the hand is on a desk in the operation. Therefore, even when the object is below, a view can be displayed on the display device. The degree of fatigue is low, and the operation can be easily performed for a long time.

(3)

With regard to an I/O device according to a third invention, in the I/O device according to the one aspect or the second invention, the depth level adjustment mechanism may include a first manual adjustment unit that can be manually adjusted.

In this case, the depth level adjustment mechanism can be manually adjusted by the first manual adjustment unit. As a result, the measurement region of the depth level sensor can be easily and surely adjusted.

(4)

With regard to an I/O device according to a fourth invention, in the I/O device according to any one of the one aspect to the third invention, the depth level adjustment mechanism may make the adjustment based on determination by the control section.

In this case, the depth level adjustment mechanism can make the adjustment based on the determination by the control section. For example, the depth level adjustment mechanism may make an adjustment if the control section determines that the object has performed a predetermined operation or if the depth level sensor does not detect the object for a predetermined time. As a result, the depth level can be automatically adjusted.

(5)

With regard to an I/O device according to a fifth invention, in the I/O device according to any one of the one aspect to the fourth invention, the display device may be a head-mounted display.

In this case, the I/O device is achieved in a small-sized and attachable mode like glasses, so that the I/O device can be easily carried. Furthermore, since the head-mounted display is small, the versatility and convenience can be enhanced.

(6)

An I/O program according to another aspect includes a display process of generating a stereoscopic image; a depth level sensor process of measuring a distance to an object; a control process of displaying a view in the display process according to the depth level sensor process; and a depth level adjustment process of adjusting at least one of a region width and a region position of a measurement region of the depth level sensor process.

In the present invention, the stereoscopic image can be generated in the display process, the distance to the object is measured in the depth level sensor process, and in the control process, the view is displayed in the display process according to the depth level sensor process. At least one of the region width and the region position of the measurement region of the depth level sensor process is adjusted in the depth level adjustment process.

In this case, at least one of the region width and the region position of the measurement region of the depth level sensor process can be adjusted in the depth level adjustment process. Therefore, the region width can be adjusted in the depth level adjustment process to adjust the region to a large width or the region to a small width. Furthermore, in the depth level adjustment process, the region position can be adjusted to a vertically upper region position, a vertically lower region position, a horizontally left region position, and a horizontally right region position.

(7)

With regard to an I/O program according to a seventh invention, in the I/O program according to the other aspect, the depth level adjustment process may include a below adjustment process of making an adjustment to provide the measurement region below a horizontal plane.

In this case, the measurement region can be provided below the horizontal plane in the depth level adjustment process. More specifically, since the measurement region can be provided below the horizontal plane in the depth level adjustment process, a hand that is the object can be measured in the depth level sensor process, and a view can be displayed in the display process even when the hand is on or near the knee in the operation or when the hand is on a desk in the operation. Therefore, even when the object is below, a view can be displayed in the display process. The degree of fatigue is low, and the operation can be easily performed for a long time.

(8)

With regard to an I/O program according to an eighth invention, in the I/O program according to the other aspect or the seventh invention, the adjustment process may be executed in the depth level adjustment process based on determination in the control process.

In this case, the adjustment can be made in the depth level adjustment process based on the determination by the control section. For example, an adjustment can be made in the depth level adjustment process if it is determined in the control process that the object has performed a predetermined operation or if the object is not detected for a predetermined time in the depth level sensor process. As a result, the depth level can be automatically adjusted.

(9)

An I/O method according to still another aspect includes: a display step of generating a stereoscopic image; a depth level sensor step of measuring a distance to an object; a control step of displaying a view in the display step according to the depth level sensor step; and a depth level adjustment step of adjusting at least one of a region width and a region position of a measurement region of the depth level sensor step.

In the present invention, the stereoscopic image can be generated in the display step, the distance to the object is measured in the depth level sensor step, and in the control step, the view is displayed in the display step according to the depth level sensor step. At least one of the region width and the region position of the measurement region of the depth level sensor step is adjusted in the depth level adjustment step.

In this case, at least one of the region width and the region position of the measurement region of the depth level sensor step can be adjusted in the depth level adjustment step. Therefore, the region width can be adjusted in the depth level adjustment step to adjust the region to a large width or the region to a small width. Furthermore, in the depth level adjustment step, the region position can be adjusted to a vertically upper region position, a vertically lower region position, a horizontally left region position, and a horizontally right region position.

(10)

With regard to an I/O method according to a tenth invention, in the I/O method according to the still another aspect, an adjustment may be made in the depth level adjustment step to provide the measurement region below a horizontal plane.

In this case, the measurement region can be provided below the horizontal plane in the depth level adjustment step. More specifically, since the measurement region can be provided below the horizontal plane in the depth level adjustment step, a hand that is the object can be measured in the depth level sensor step, and a view can be displayed in the display step even when the hand is on or near the knee in the operation or when the hand is on a desk in the operation. Therefore, even when the object is below, a view can be displayed in the display step. The degree of fatigue is low, and the operation can be easily performed for a long time.

(11)

With regard to an I/O method according to an eleventh invention, in the I/O method according to the still another aspect or the tenth invention, the adjustment may be made in the depth level adjustment step based on determination in the control step.

In this case, the adjustment can be made in the depth level adjustment step based on the determination in the control step. For example, an adjustment can be made in the depth level adjustment step if it is determined in the control step that the object has performed a predetermined operation or if the object is not detected for a predetermined time in the depth level sensor step. As a result, the depth level can be automatically adjusted.

### BRIEF DESCRIPTION OF DRAWINGS

FIG. 1 is a schematic external front view illustrating an example of a basic configuration of a glasses display device according to an embodiment.

FIG. 2 is a schematic external perspective view illustrating an example of the glasses display device.

FIG. 3 is a schematic diagram illustrating an example of a configuration of a control unit of an operation system.

FIG. 4 is a flowchart illustrating a processing flow in the operation system.

FIG. 5 is a schematic diagram illustrating a concept corresponding to the flowchart of FIG. 4.

FIG. 6 is a schematic perspective view for describing a detection region of an infrared ray detection unit and a virtual display region of a pair of semi-transmissive displays.

FIG. 7 is a top view of FIG. 6.

FIG. 8 is a side view of FIG. 6.

FIG. 9 is a schematic diagram illustrating another example of the detection region and the virtual display region.

FIG. 10 is a schematic diagram illustrating another example of the detection region and the virtual display region.

FIG. 11 is a schematic diagram illustrating another example of the detection region and the virtual display region.

FIG. 12 is a schematic diagram illustrating an example of a manipulation region and a gesture region in the detection region.

FIG. 13 is a schematic diagram illustrating an example of the manipulation region and the gesture region in the detection region.

FIG. 14 is a flowchart for describing a calibration process.

FIG. 15 is a schematic diagram illustrating an example of finger recognition.

FIG. 16 is a flowchart illustrating an example of a finger recognition process.

FIG. 17 is a schematic diagram illustrating an example of palm recognition.

FIG. 18 is a schematic diagram illustrating an example of thumb recognition.

FIG. 19 is a schematic diagram illustrating an example of a view of the semi-transmissive display of the glasses display device.

FIG. 20 is a schematic diagram illustrating another example of the manipulation region and the gesture region in the detection region.

FIG. 21 is a schematic diagram illustrating a specific example of FIG. 20.

FIG. 22 is a schematic diagram illustrating the specific example of FIG. 20.

FIG. 23 is a schematic diagram illustrating an example of the view of the semi-transmissive display in the specific example illustrated in FIG. 21 and FIG. 22.

FIG. 24 is a schematic diagram illustrating another example of FIG. 12 and FIG. 13.

FIG. 25 is a schematic diagram illustrating the other example of FIG. 12 and FIG. 13.

FIG. 26 is a schematic diagram illustrating an A-A line cross section of FIG. 1.

FIG. 27 is a schematic diagram illustrating an example in which the pair of semi-transmissive displays is adjusted by display adjustment mechanisms.

FIG. 28 is a schematic diagram illustrating an example in which the pair of semi-transmissive displays is adjusted by the display adjustment mechanisms.

FIG. 29 is a schematic diagram illustrating a B-B line cross section of FIG. 2.

FIG. 30 is a schematic diagram illustrating an example in which the pair of semi-transmissive displays is adjusted by the display adjustment mechanisms.

FIG. 31 is a schematic diagram illustrating an example in which the pair of semi-transmissive displays is adjusted by the display adjustment mechanisms.

### REFERENCE SIGNS LIST

100 glasses display device
220 semi-transmissive display
2203D virtual image display region (common region)
300 communication system
303 camera unit
410 infrared ray detection unit
410c manipulation region
420 gyroscope unit
430 acceleration detection unit
4103D three-dimensional space detection region
450 control unit
454 anatomy recognition unit
456 gesture recognition unit
460 event service unit
461 calibration service unit
900 I/O device
H1 hand
RP right shoulder joint
LP left shoulder joint

### DESCRIPTION OF EMBODIMENT

Hereinafter, an embodiment of the present invention is described with reference to the drawings. In the following description, the same reference signs are given to the same components. The names and functions thereof are the same. Accordingly, detailed description thereof is not repeated.

Moreover, the present invention is not limitatively applied to the following glasses display device, and can also be applied to other wearable devices, other I/O devices, display devices, televisions, monitors, projectors, and the like.

### (Configuration Outline of Glasses Display Device)

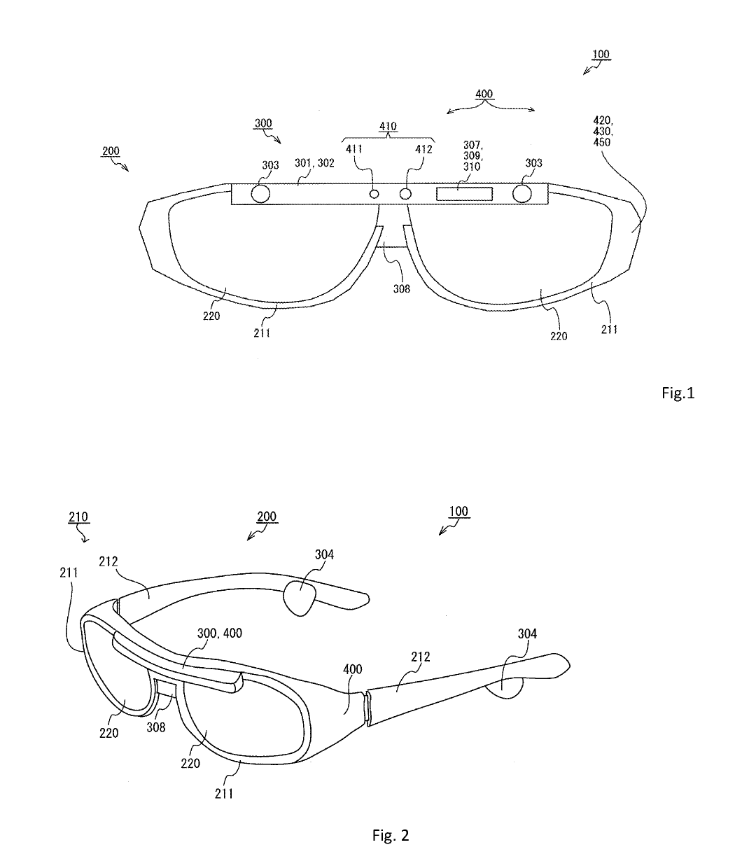

FIG. 1 is a schematic external front view illustrating an example of a basic configuration of a glasses display device 100 according to an embodiment, and FIG. 2 is a schematic external perspective view illustrating an example of the glasses display device 100.

As illustrated in FIG. 1 or FIG. 2, the glasses display device 100 is a glasses-shaped display device. As described later, the glasses display device 100 is used while being attached to the face of a user.

As illustrated in FIG. 1 and FIG. 2, the glasses display device 100 mainly includes a glasses unit 200, a communication system 300, and an operation system 400.

### (Glasses Unit 200)

As illustrated in FIG. 1 and FIG. 2, the glasses unit 200 includes a glasses frame 210, a pair of semi-transmissive displays 220, and a pair of display adjustment mechanisms 600. The glasses frame 210 mainly includes a rim unit 211 and a temple unit 212.

The pair of semi-transmissive displays 220 is supported by the rim unit 211 of the glasses frame 210. The rim unit 211 is provided with the pair of display adjustment mechanisms 600. The rim unit 211 is also provided with an infrared ray detection unit 410 and a unit adjustment mechanism 500. Details of the unit adjustment mechanism 500 will be described later.

The pair of display adjustment mechanisms 600 can adjust the angle and the position of the pair of semi-transmissive displays 220 as described later. Details of the pair of display adjustment mechanisms 600 will be described later.

In the present embodiment, the pair of display adjustment mechanisms 600 of the rim unit 211 of the glasses display device 100 is provided with the pair of semi-transmissive displays 220. Not limited thereto, the pair of display adjustment mechanisms 600 of the rim unit 211 of the glasses display device 100 may be provided with lenses such as normal sunglasses lenses, ultraviolet protection lenses, or glasses lenses, and one semi-transmissive display 220 or the pair of semi-transmissive displays 220 may be separately provided.

Alternatively, the semi-transmissive display(s) 220 may be provided so as to be embedded in part of the lenses.

Furthermore, although the pair of display adjustment mechanisms 600 is provided on a side portion of the semi-transmissive displays 220, not limited thereto, the pair of display adjustment mechanisms 600 may be provided around or inside of the semi-transmissive displays 200.

Further, the present embodiment is not limited to such a glasses type, and can be applied to a hat type and other arbitrary head-mounted display devices as long as the device can be attached to the body of a person and can be arranged within the field of view of the person.

### (Communication System 300)

Next, the communication system 300 is described.

The communication system 300 includes a battery unit 301, an antenna module 302, a camera unit 303, a speaker unit 304, a global positioning system (GPS) unit 307, a microphone unit 308, a subscriber identity module card (SIM) unit 309, and a main unit 310.

Note that the camera unit may be provided with a CCD sensor. The speaker unit 304 may be normal earphones, and may be bone-conduction earphones. The SIM unit 309 includes a near field communication (NFC) unit, another contact-type IC card unit, and a contactless IC card unit.

As described above, the communication system 300 according to the present embodiment at least has any of the functions of a mobile phone, a smartphone, and a tablet terminal. Specifically, the communication system 300 has a phone function, an Internet function, a browser function, an e-mail function, an image taking function, and the like.

Accordingly, with the use of the glasses display device 100, the user can use a phone call function similar to that of a mobile phone by means of the communication device, the speaker, and the microphone. Moreover, because the glasses display device 100 is glasses-shaped, the user can make a phone call without using both his/her hands.

### (Operation System 400)

Next, the operation system 400 includes an infrared ray detection unit 410, a gyroscope unit 420, an acceleration detection unit 430, and a control unit 450. The infrared ray detection unit 410 mainly includes an infrared ray emission element 411 and an infrared ray detection camera 412.

### (Unit Adjustment Mechanism 500)

As illustrated in FIG. 2, the unit adjustment mechanism 500 can adjust the angle of the infrared ray detection unit 410. Specifically, the unit adjustment mechanism 500 has a structure that allows adjusting the angle of the infrared ray detection unit 410 around a horizontal axis of an arrow V5 and around a vertical axis of an arrow H5.

The unit adjustment mechanism 500 makes a movement and adjustment in the directions of the arrow V5 and the arrow H5 according to an instruction from the control unit 450.

For example, when a predetermined gesture is recognized by the control unit 450, the unit adjustment mechanism 500 may be operated at a predetermined angle. In this case, the user can perform a predetermined gesture to adjust the angle of the infrared ray detection unit 410.

Note that, although the control unit 450 causes the unit adjustment mechanism 500 to operate in the present embodiment, not limited thereto, an adjustment unit 520 of FIG. 1 may be able to be manually operated to make a movement and adjustment in the direction of the arrow V5 and the direction of the arrow H5.

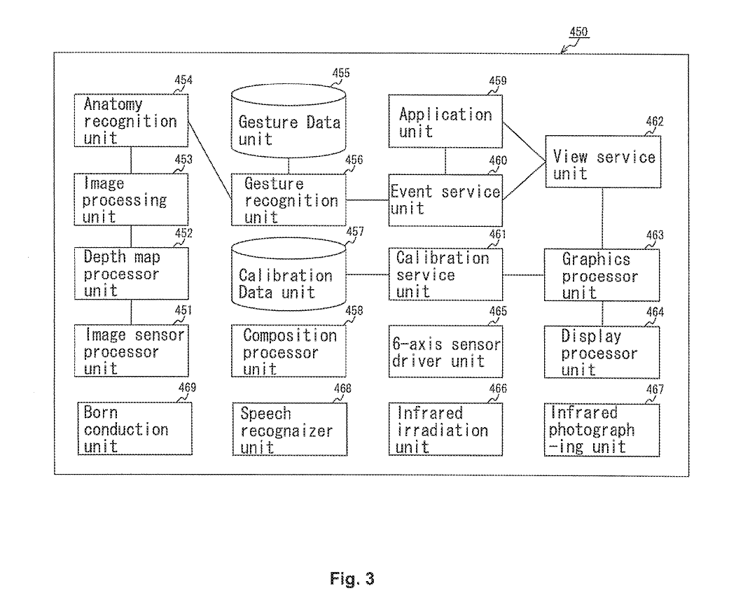

Next, a configuration, a processing flow, and a concept of the operation system 400 are described. FIG. 3 is a schematic diagram illustrating an example of a configuration of the control unit 450 of the operation system 400.

As illustrated in FIG. 3, the control unit 450 includes an image sensor processor unit 451, a depth map processor unit 452, an image processing unit 453, an anatomy recognition unit 454, a gesture data unit 455, a gesture recognition unit 456, a calibration data unit 457, a composition processor unit 458, an application unit 459, an event service unit 460, a calibration service unit 461, a view service unit 462, a graphics processor unit 463, a display processor unit 464, and a 6-axis sensor driver unit 465.

Note that the control unit 450 does not need to include all the above-mentioned units, and may include one or more necessary units as appropriate. For example, the gesture data unit 455 and the calibration data unit 457 may be arranged on a cloud service, and the composition processor unit 458 may not be particularly provided.

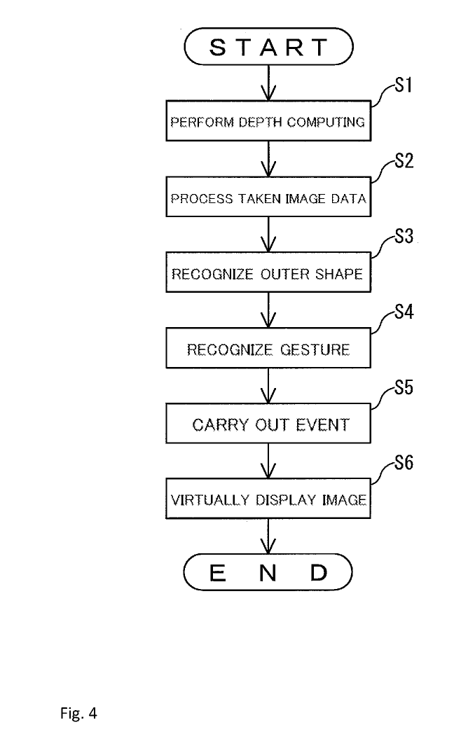

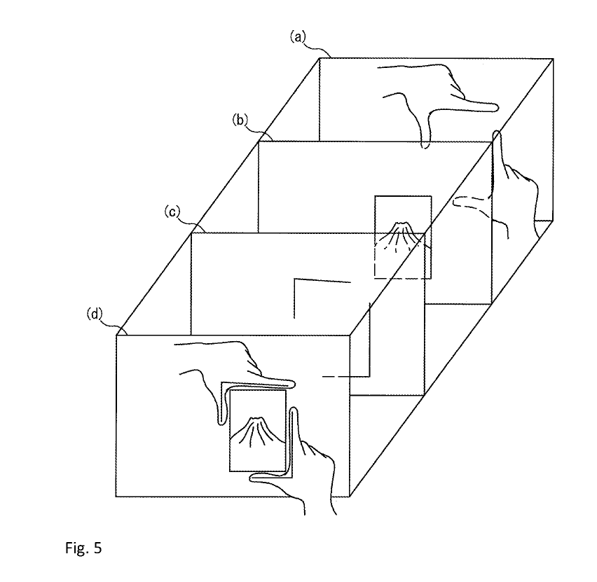

Next, FIG. 4 is a flowchart illustrating a processing flow in the operation system 400, and FIG. 5 is a schematic diagram illustrating a concept according to the flowchart of FIG. 4.

First, as illustrated in FIG. 4, target data is acquired from the infrared ray detection unit 410, and depth computing is performed by the depth map processor unit 452 (Step S1). Then, outer shape image data is processed by the image processing unit 453 (Step S2).

Subsequently, on the basis of the structure of a standard human body, an anatomic feature is recognized from the outer shape image data processed in Step S2, by the anatomy recognition unit 454. As a result, an outer shape is recognized (Step S3).

Further, on the basis of the anatomic feature obtained in Step S3, a gesture is recognized by the gesture recognition unit 456 (Step S4).

The gesture recognition unit 456 refers to gesture data recorded in the gesture data unit 455, and recognizes the gesture from the outer shape whose anatomic feature has been recognized. Note that, although it is assumed that the gesture recognition unit 456 refers to the gesture data recorded in the gesture data unit 455, not limited thereto, the gesture recognition unit 456 may refer to other arbitrary data, and may perform processing without any reference.

In such a manner as described above, a gesture of hands is recognized as illustrated in FIG. 5(a).

Subsequently, the application unit 459 and the event service unit 460 carry out a predetermined event in accordance with the gesture recognized by the gesture recognition unit 456 (Step S5).

As a result, as illustrated in FIG. 5(b), for example, an image is displayed by a picture application. On this occasion, taken image data from the camera unit 303 may be displayed on this screen.

Lastly, the view service unit 462, the calibration service unit 461, the graphics processor unit 463, the display processor unit 464, and the composition processor unit 458 display or virtually display an image on the semi-transmissive displays 220 (Step S6). As a result, skeletons of the hands indicating the gesture are displayed as illustrated in FIG. 5(c), and a composite image that is formed such that the shape and size of a picture coincide with the shape and size of the skeletons is displayed as illustrated in FIG. 5(d).

Note that the 6-axis sensor driver unit 465 always detects signals from the gyroscope unit 420 and the acceleration detection unit 430, and transmits a posture condition to the display processor unit 464.

In the case where the user to whom the glasses display device 100 is attached inclines the glasses display device 100, the 6-axis sensor driver unit 465 always receives signals from the gyroscope unit 420 and the acceleration detection unit 430, and controls image display. In this control, the displayed image may be kept horizontal, and may be adjusted in accordance with the inclination.

### (One Example of Detection Region and Virtual Display Region)

Next, a relation between a detection region of the infrared ray detection unit 410 of the operation system 400 and a virtual display region of the pair of semi-transmissive displays 220 is described.

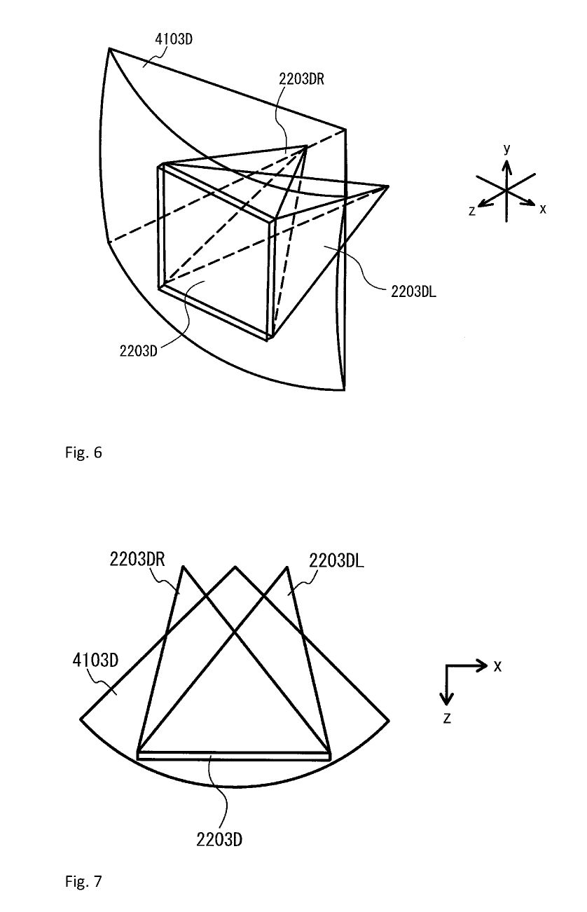

FIG. 6 is a schematic perspective view for describing the detection region of the infrared ray detection unit 410 and the virtual display region of the pair of semi-transmissive displays 220, FIG. 7 is a top view of FIG. 6, and FIG. 8 is a side view of FIG. 6.

In the following, for convenience of description, a three-dimensional orthogonal coordinate system formed by an x-axis, a y-axis, and a z-axis is defined as illustrated in FIG. 6. In the following drawings, an x-axis arrow indicates the horizontal direction. A y-axis arrow indicates the vertical direction or the long axis direction of the user's body. A z-axis arrow indicates the depth level direction. The z-axis positive direction indicates the direction of a higher depth level. The direction of each arrow is the same in the other drawings.

As illustrated in FIG. 6 to FIG. 8, a three-dimensional space detection region (3D space) 4103D in which detection by the infrared ray detection unit 410 of the operation system 400 is possible is provided.

The three-dimensional space detection region 4103D is formed by a conical or pyramidal three-dimensional space extending from the infrared ray detection unit 410.

That is, infrared rays emitted from the infrared ray emission element 411 can be detected by the infrared ray detection camera 412, and hence the infrared ray detection unit 410 can recognize a gesture in the three-dimensional space detection region 4103D.

Moreover, although one infrared ray detection unit 410 is provided in the present embodiment, not limited thereto, a plurality of the infrared ray detection units 410 may be provided, and one infrared ray emission element 411 and a plurality of the infrared ray detection cameras 412 may be provided.

Subsequently, as illustrated in FIG. 6 to FIG. 8, the pair of semi-transmissive displays 220 is visually recognized by the user as a virtual display with a depth in not an actual place of the glasses display device 100 but a virtual image display region 2203D that is a place apart from the glasses display device 100. The depth corresponds to the thickness in the depth level direction (z-axis direction) of a virtual stereoscopic shape of the virtual image display region 2203D. Accordingly, the depth is provided in accordance with the thickness in the depth level direction (z-axis direction) of the virtual stereoscopic shape.

That is, although images are respectively displayed on the semi-transmissive displays 220 of the glasses display device 100 in actuality, a right-eye image is transmitted through the semi-transmissive display 220 on the right-eye side to be recognized by the user in a three-dimensional space region 2203DR, and a left-eye image is transmitted through the semi-transmissive display 220 on the left-eye side to be recognized by the user in a three-dimensional space region 2203DL. As a result, the two recognized images are composited with each other in the brain of the user, whereby the user can recognize the two images as a virtual image in the virtual image display region 2203D.

Moreover, the virtual image display region 2203D is displayed using any of a frame sequential method, a polarization method, a linear polarization method, a circular polarization method, a top-and-bottom method, a side-by-side method, an anaglyph method, a lenticular method, a parallax barrier method, a liquid crystal parallax barrier method, a two-parallax method, and a multi-parallax method using three or more parallaxes.

Moreover, in the present embodiment, the virtual image display region 2203D includes a space region common to the three-dimensional space detection region 4103D. In particular, as illustrated in FIG. 6 and FIG. 7, the virtual image display region 2203D exists inside of the three-dimensional space detection region 4103D, and hence the virtual image display region 2203D corresponds to the common region.

Note that the shape and size of the virtual image display region 2203D can be arbitrarily adjusted by a display method on the pair of semi-transmissive displays 220.

Moreover, as illustrated in FIG. 8, description is given above of the case where the infrared ray detection unit 410 is arranged above (y-axis positive direction) the pair of semi-transmissive displays 220. Even if the arrangement position in the vertical direction (y-axis direction), of the infrared ray detection unit 410 is below (y-axis negative direction) the semi-transmissive displays 220 or the same as the position of the semi-transmissive displays 220, the virtual image display region 2203D similarly includes a space region common to the three-dimensional space detection region 4103D.

### (Other Examples of Detection Region and Virtual Display Region)

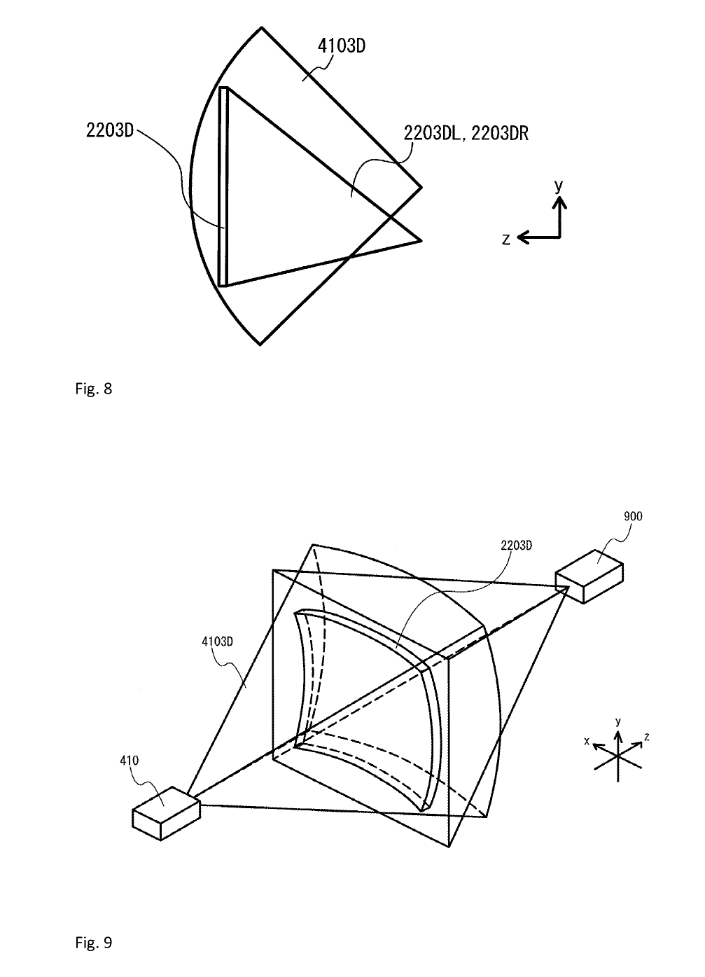

Next, FIG. 9 to FIG. 11 are schematic diagrams respectively illustrating other examples of the detection region and the virtual display region illustrated in FIG. 6 to FIG. 8.

For example, as illustrated in FIG. 9 to FIG. 11, other I/O devices, display devices, televisions, monitors, and the like may be used instead of the semi-transmissive displays 220 of the glasses display device 100. Hereinafter, other I/O devices, display devices, televisions, monitors, and projectors are collectively referred to as an I/O device 900.

As illustrated in FIG. 9, the virtual image display region 2203D may be outputted in the z-axis negative direction from the I/O device 900, and the three-dimensional space detection region 4103D may be formed in the z-axis positive direction from the infrared ray detection unit 410 that is positioned so as to be opposed to the I/O device 900 in the z-axis direction.

In this case, the virtual image display region 2203D outputted by the I/O device 900 is generated as a space region common to the three-dimensional space detection region 4103D.

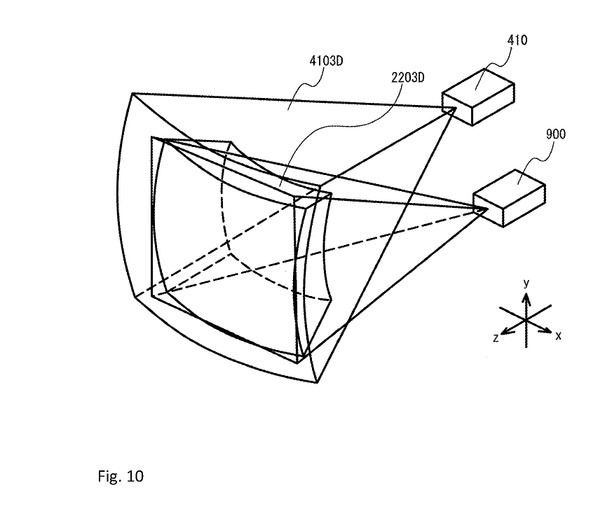

Moreover, as illustrated in FIG. 10, the virtual image display region 2203D may be outputted from the I/O device 900, and the three-dimensional space detection region 4103D of the infrared ray detection unit 410 may be formed in the same direction as that of the I/O device 900 (both in the z-axis positive direction with respect to the x-y plane).

Also in this case, the virtual image display region 2203D outputted by the I/O device 900 is generated as a space region common to the three-dimensional space detection region 4103D.

Then, as illustrated in FIG. 11, the virtual image display region 2203D may be outputted in the vertical upward direction (y-axis positive direction) from the I/O device 900. Also in FIG. 11, similarly to FIG. 9 and FIG. 10, the virtual image display region 2203D outputted by the I/O device 900 is generated as a space region common to the three-dimensional space detection region 4103D.

Moreover, although not illustrated, the I/O device 900 may be arranged on the upper side (y-axis positive direction side) of the three-dimensional space detection region 4103D, and the virtual image display region 2203D may be outputted in the vertical downward direction (y-axis negative direction). The virtual image display region 2203D may be outputted in the horizontal direction (x-axis direction). Like a projector or a movie theater, the virtual image display region 2203D may be outputted from the upper back side (the z-axis positive direction and the y-axis positive direction).

### (Manipulation Region and Gesture Region)

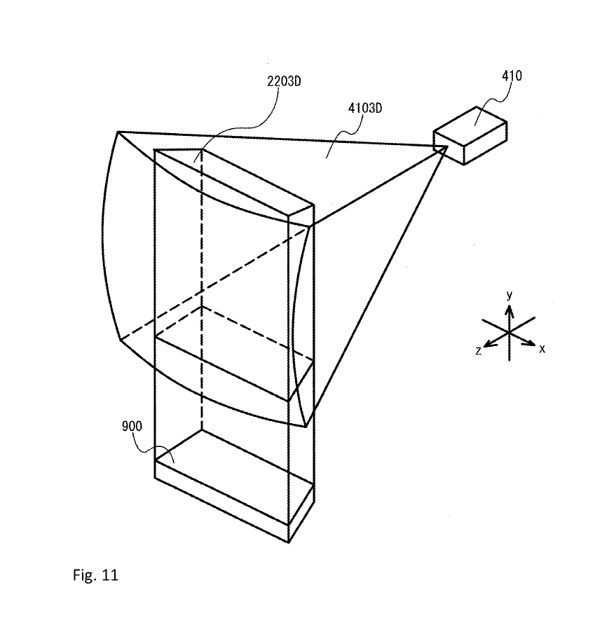

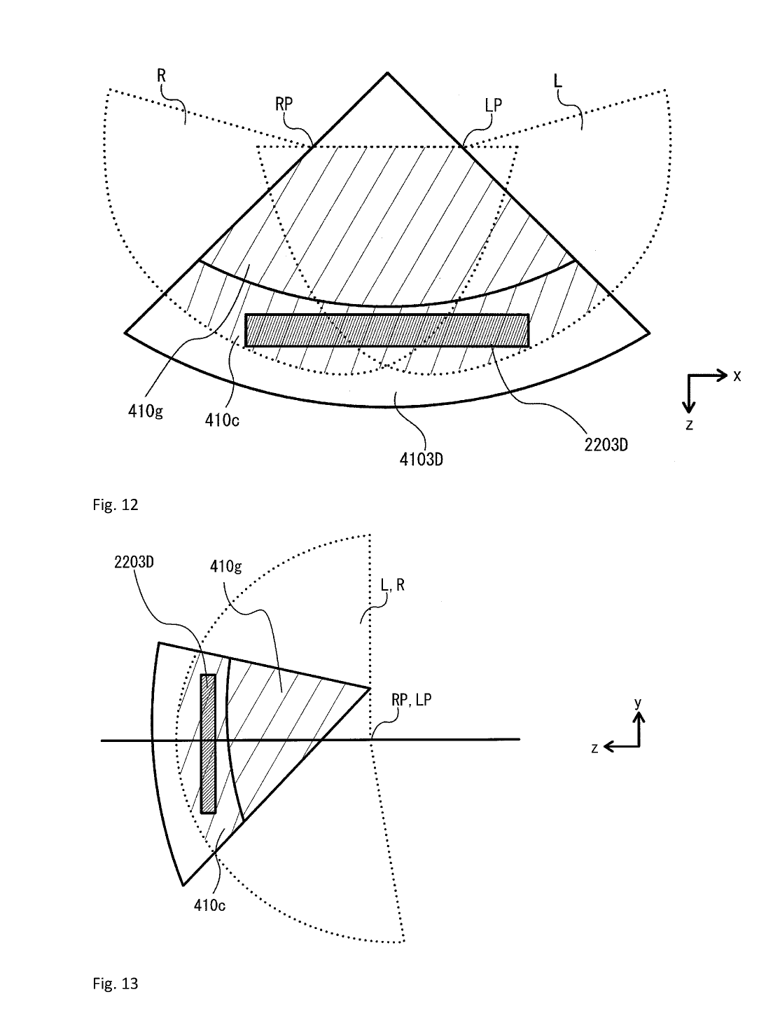

Next, a manipulation region and a gesture region in the detection region are described. FIG. 12 and FIG. 13 are schematic diagrams illustrating an example of the manipulation region and the gesture region in the detection region.

First, as illustrated in FIG. 12, in general, the user horizontally moves both his/her hands about both his/her shoulder joints (a right shoulder joint RP and a left shoulder joint LP) as the respective centers of rotation, and hence both his/her hands can respectively move within a movement region L and a movement region R surrounded by dotted lines.

Moreover, as illustrated in FIG. 13, in general, the user vertically moves both his/her hands about both his/her shoulder joints (the right shoulder joint RP and the left shoulder joint LP) as the respective centers of rotation, and hence both his/her hands can respectively move within the movement region L and the movement region R surrounded by dotted lines.

That is, as illustrated in FIG. 12 and FIG. 13, the user can move both his/her hands about the right shoulder joint RP and the left shoulder joint LP as the respective centers of rotation, in a three-dimensional space having an imperfect spherical shape (having an arch-like curved surface that is convex in the depth level direction).

Then, an overlapping space region of all of: the three-dimensional space detection region 4103D of the infrared ray detection unit 410; a region in which a virtual image display region can exist (in FIG. 12, the virtual image display region 2203D is illustrated as an example); and a region obtained by integrating the arm movement region L and the arm movement region R is set as a manipulation region 410c.

Moreover, a portion other than the manipulation region 410c in the three-dimensional space detection region 4103D is set as a gesture region 410g, the portion overlapping with the region obtained by integrating the arm movement region L and the arm movement region R.

Here, the manipulation region 410c has a stereoscopic shape whose farthest surface in the depth level direction is an arch-like curved surface that is convex in the depth level direction (z-axis positive direction), whereas the virtual image display region 2203D has a stereoscopic shape whose farthest surface in the depth level direction is a planar surface. Due to such a difference in the shape of the farthest surface between the two regions, the user physically feels a sense of discomfort during the manipulation. In order to solve the sense of discomfort, adjustment is performed in a calibration process. Moreover, the details of the calibration process are described below.

### (Description of Calibration)

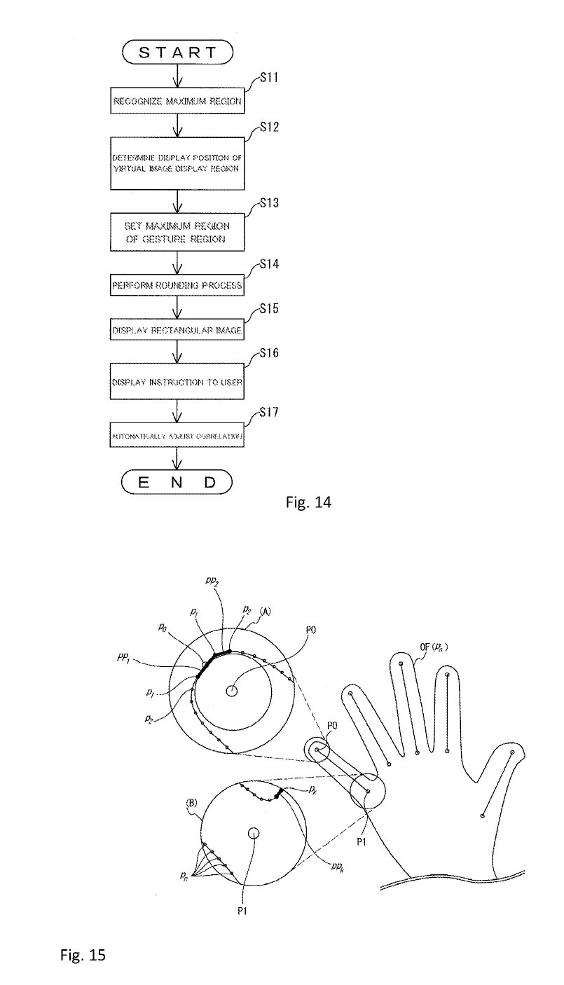

Next, the calibration process is described. FIG. 14 is a flowchart for describing the calibration process.

As illustrated in FIG. 12 and FIG. 13, when the user tries to move his/her hand(s) along the virtual image display region 2203D, the user needs to move his/her hand(s) along a plane without any guide. Accordingly, the calibration process is performed to facilitate the manipulation in the virtual image display region 2203D through a recognition process to be described below.

Moreover, in the calibration process, the finger length, the hand length, and the arm length, which are different for each user, are also adjusted.

Hereinafter, description is given with reference to FIG. 14. First, the glasses display device 100 is attached to the user, and the user maximally stretches both his/her arms. As a result, the infrared ray detection unit 410 recognizes the maximum region of the manipulation region 410c (Step S11).

That is, because the finger length, the hand length, and the arm length are different for each user, the manipulation region 410c is adjusted to suit each user.

Then, in the glasses display device 100, a display position of the virtual image display region 2203D is determined (Step S12). That is, if the virtual image display region 2203D is arranged outside of the manipulation region 410c, a user's manipulation becomes impossible, and hence the virtual image display region 2203D is arranged inside of the manipulation region 410c.

Subsequently, the maximum region of the gesture region 410g is set within the three-dimensional space detection region 4103D of the infrared ray detection unit 410 of the glasses display device 100 so as not to overlap with the display position of the virtual image display region 2203D (Step S13).

Note that it is preferable that the gesture region 410g be arranged so as not to overlap with the virtual image display region 2203D and be provided with a thickness in the depth direction (z-axis positive direction).

In the present embodiment, the manipulation region 410c, the virtual image display region 2203D, and the gesture region 410g are set in such a manner as described above.

Next, calibration of the virtual image display region 2203D in the manipulation region 410c is described.

In the case where it is determined that the finger(s), the hand(s), or the arm(s) of the user exist around the outside of the virtual image display region 2203D in the manipulation region 410c, such rounding as if the finger(s), the hand(s), or the arm(s) of the user existed inside of the virtual image display region 2203D is performed (Step S14).

As illustrated in FIG. 12 and FIG. 13, in a region near a central part of an image virtually displayed by the semi-transmissive displays 220, if the user maximally stretches both his/her arms, the tips of both his/her hands do not stay within the virtual image display region 2203D and go out thereof in the depth direction (z-axis positive direction). Meanwhile, in an end part of the virtually displayed image, unless the user maximally stretches both his/her arms, it is not determined that the tips of both his/her hands exist within the virtual image display region 2203D.

Hence, if a signal from the infrared ray detection unit 410 is used without being processed, even if the tips of his/her hands go out of the virtual image display region 2203D, the user has difficulty in physically feeling such a state.

Accordingly, in the process of Step S14 in the present embodiment, the signal from the infrared ray detection unit 410 is processed such that the tips of his/her hands that protrude to the outside of the virtual image display region 2203D are corrected to exist within the virtual image display region 2203D.

As a result, in the state where the user maximally stretches or slightly bends both his/her arms, a manipulation from the central part to the end part in the planar virtual image display region 2203D with a depth is possible.

Note that, although the virtual image display region 2203D is formed by a three-dimensional space region whose farthest surface in the depth level direction is a planar surface in the present embodiment, not limited thereto, the virtual image display region 2203D may be formed by a three-dimensional space region that is a curved surface having a shape along the farthest surfaces in the depth level direction of the farthest surface regions L and R in the depth level direction. As a result, in the state where the user maximally stretches or slightly bends both his/her arms, a manipulation from the central part to the end part in the planar virtual image display region 2203D with a depth is possible.

Further, the semi-transmissive displays 220 display a rectangular image in the virtual image display region 2203D. For example, as illustrated in FIG. 5(b), the semi-transmissive displays 220 display a rectangular image (Step S15).

Subsequently, an instruction to the effect that “please surround the displayed image with your fingers” is displayed on the semi-transmissive displays 220 (Step S16). Here, a finger-shaped image may be softly displayed in the vicinity of the image, and a vocal instruction from the speaker may be given to the user instead of such display on the semi-transmissive displays 220.

According to the instruction, the user places his/her fingers on a portion of the image as illustrated in FIG. 5(d). Then, a correlation between the display region of the virtual image display region 2203D and the infrared ray detection unit 410 is automatically adjusted (Step S17).

Note that, in the above example, the user defines a rectangular with his/her fingers, and places the rectangular thus defined on the rectangular of the outer edge of the image. For this reason, the visual recognition size and position of the rectangular defined by his/her fingers is made coincident with the visual recognition size and position of the rectangular of the outer edge of the image. However, the method of defining a shape with fingers is not limited thereto, and may be other arbitrary methods such as a method of tracing the outer edge of the displayed image with a finger and a method of pointing to a plurality of points on the outer edge of the displayed image with a finger. Moreover, these methods may be applied to images having a plurality of sizes.

Note that, although only the case of the glasses display device 100 is taken in the above description of the calibration process, in the case of the I/O device 900, an image may be displayed in the process of Step S11, and a correlation between the displayed image and the infrared ray detection unit 410 may be adjusted in the process of Step S17.

### (Finger, Palm, and Arm Recognition)

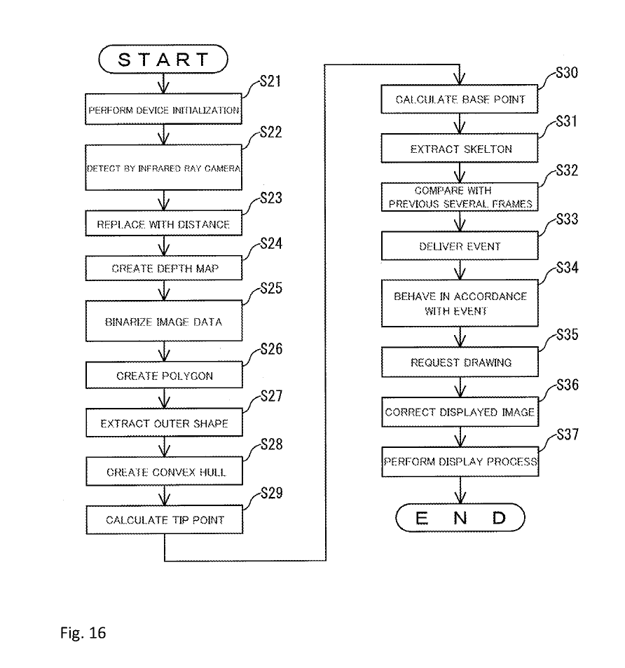

Next, finger recognition is described, followed by description of palm recognition and arm recognition in the stated order. FIG. 15 is a schematic diagram illustrating an example of the finger recognition. In FIG. 15, (A) is an enlarged view of the vicinity of the tip of a finger, and (B) is an enlarged view of the vicinity of the base of the finger. FIG. 16 is a flowchart illustrating an example of the finger recognition process.

As illustrated in FIG. 16, in the present embodiment, device initialization is performed (Step S21). Then, an infrared ray that has been emitted from the infrared ray emission element 411 and has been reflected on a hand is detected by the infrared ray detection camera 412 (Step S22).

Then, image data is replaced with a distance on a pixel basis by the infrared ray detection unit 410 (Step S23). In this case, the luminance of the infrared ray is inversely proportional to the cube of the distance. A depth map is created using this fact (Step S24).

Subsequently, an appropriate threshold is set to the created depth map. Then, the image data is binarized (Step S25). That is, noise is removed from the depth map.

Subsequently, a polygon having about 100 vertexes is created from the binarized image data (Step S26). Then, a new polygon having a larger number of vertexes pₙ is created using a low-pass filter (LPF) such that the vertexes become smoother, whereby an outer shape OF of the hand illustrated in FIG. 15 is extracted (Step S27).

Note that, although the number of vertexes that are extracted from the data binarized in Step S26 in order to create a polygon is about 100 in the present embodiment, not limited thereto, the number of vertexes may be 1,000 or other arbitrary numbers.

### (Finger Recognition)

A convex hull is extracted using Convex Hull from the set of the vertexes pₙ of the new polygon created in Step S27 (Step S28).

After that, a vertex p₀ common between the new polygon created in Step S27 and the convex hull created in Step S28 is extracted (Step S29). The common vertex p₀ itself thus extracted can be used as a tip point of the finger.

Further, another point calculated on the basis of the position of the vertex p₀ may be used as the tip point of the finger. For example, as illustrated in FIG. 15(A), the center of an inscribed circle of the outer shape OF at the vertex p₀ may also be calculated as a tip point P0.

Then, as illustrated in FIG. 15, a vector of a reference line segment PP₁ that passes through a pair of right and left vertexes p₁ adjacent to the vertex p₀ is calculated. After that, a side pp₂ connecting each vertex p₁ and a vertex p₂ adjacent thereto is selected, and a vector of the side pp₂ is calculated. Similarly, with the use of the vertexes pₙ forming the outer shape OF, such a process of obtaining a vector of each side is repeated along the outer periphery of the outer shape OF. The direction of each side and the direction of the reference line segment PP₁ calculated in the process of Step S30 are compared with each other, and a side ppₖ that is close to parallel to the reference line segment PP₁ is determined to exist at the position of a valley between fingers. Then, a base point P1 of the finger is calculated on the basis of the position of the side ppₖ (Step S30). A skeleton of the finger can be obtained by connecting the tip point P0 of the finger and the base point P1 of the finger using a straight line (Step S31). If the skeleton of the finger are obtained, the extending direction of the finger can be recognized.

A similar process is performed on all the fingers, whereby the skeletons of all the fingers are obtained. As a result, the pose of the hand can be recognized. That is, it can be recognized which of the thumb, the index finger, the middle finger, the ring finger, and the little finger is stretched and which thereof is bent.

Subsequently, a difference in the pose of the hand is detected in comparison with image data of several frames taken immediately before (Step S32). That is, movement of the hand can be recognized through the comparison with the image data of the several frames taken immediately before.

Subsequently, the recognized shape of the hand is event-delivered as gesture data to the event service unit 460 (Step S33).

Subsequently, a behavior according to the event is carried out by the application unit 459 (Step S34).

Subsequently, drawing in a three-dimensional space is requested by the view service unit 462 (Step S35).

The graphics processor unit 463 refers to the calibration data unit 457 using the calibration service unit 461, and corrects the displayed image (Step S36).

Lastly, the resultant image is displayed on the semi-transmissive displays 220 by the display processor unit 464 (Step S37).

Note that, although the base point of each finger is detected through the process of Step S30 and the process of Step S31 in the present embodiment, the method of detecting the base point is not limited thereto. For example, first, the length of the reference line segment PP₁ is calculated, the reference line segment PP₁ connecting the pair of vertexes p₁ that are adjacent to the vertex p₀ on one side and another side of the vertex p₀, respectively. Then, the length of a line segment connecting the pair of vertexes p₂ on the one side and the another side is calculated. Similarly, the length of each line segment connecting a pair of vertexes on the one side and the another side is calculated in order from vertexes positioned closer to the vertex p₀ to vertexes positioned farther therefrom. Such line segments do not intersect with one another inside of the outer shape OF, and are substantially parallel to one another. In the case where the vertexes at both the ends of such a line segment are in the portion of the finger, the length of the line segment corresponds to the width of the finger, and hence the amount of change thereof is small. Meanwhile, in the case where at least any of the vertexes at both the ends of such a line segment reaches the portion of the valley between the fingers, the amount of change of the length becomes larger. Accordingly, a line segment that has the length whose amount of change does not exceed a predetermined amount and is the farthest from the vertex p₀ is detected, and one point on the detected line segment is extracted, whereby the base point can be determined.

### (Palm Recognition)

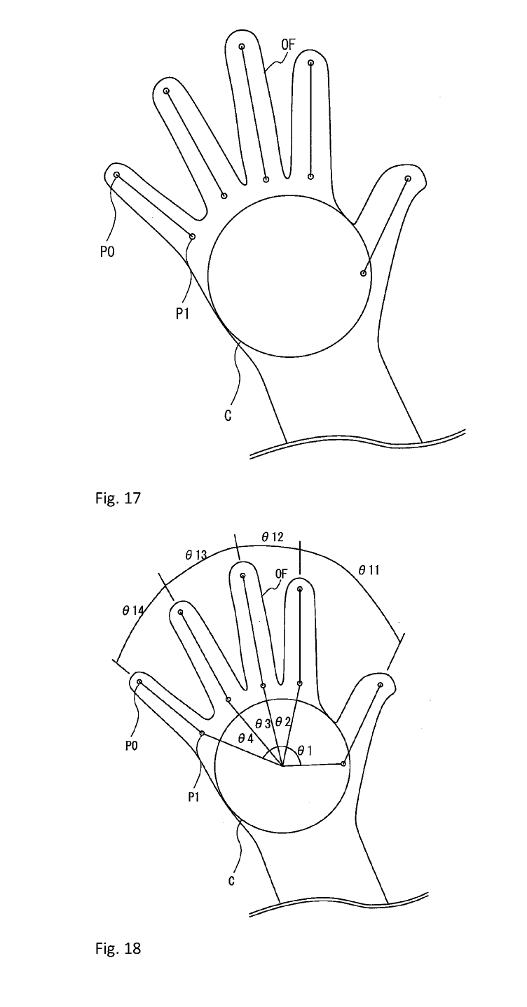

Next, FIG. 17 is a schematic diagram illustrating an example of the palm recognition.

As illustrated in FIG. 17, after the finger recognition is carried out, a maximum inscribed circle C inscribed in the outer shape OF of the image data is extracted. The position of the maximum inscribed circle C can be recognized as the position of the palm.

Next, FIG. 18 is a schematic diagram illustrating an example of thumb recognition.

As illustrated in FIG. 18, the thumb has features different from those of the other four fingers of the index finger, the middle finger, the ring finger, and the little finger. For example, among angles θ1, θ2, θ3, and Θ4 mutually formed by straight lines connecting: the center of the maximum inscribed circle C indicating the position of the palm; and the respective base points P1 of the fingers, θ1 concerning the thumb tends to be the largest. Moreover, among angles θ11, θ12, θ13, and θ14 mutually formed by straight lines connecting: the respective tip points P0 of the fingers; and the respective base points P1 of the fingers, θ11 concerning the thumb tends to be the largest. The thumb is determined on the basis of such tendencies. As a result, it can be determined whether the image data is a right hand or a left hand or whether the image data is the front side or the back side of the palm.

### (Arm Recognition)

Next, the arm recognition is described. In the present embodiment, the arm recognition is carried out after any of the fingers, the palm, and the thumb is recognized. Note that the arm recognition may also be carried out before any of the fingers, the palm, and the thumb is recognized or at the same time as at least any thereof is recognized.

In the present embodiment, a polygon is extracted from a region larger than the polygon of the shape of the hand of the image data. For example, the processes of Steps S21 to S27 are carried out in a length range of 5 cm or more and 100 cm or less and, more preferably, a length range of 10 cm or more and 40 cm or less, so that an outer shape is extracted.

After that, a quadrangular frame circumscribed around the extracted outer shape is selected. In the present embodiment, the shape of the quadrangular frame is a parallelogram or a rectangle.

In this case, because the parallelogram or the rectangle has longer sides opposed to each other, the extending direction of the arm can be recognized from the extending direction of the longer sides, and the direction of the arm can be determined from the direction of the longer sides. Note that, similarly to the process of Step S32, movement of the arm may be detected in comparison with image data of several frames taken immediately before.

Note that, although the fingers, the palm, the thumb, and the arm are detected from a two-dimensional image in the above description, not limited thereto, the infrared ray detection unit 410 may be further provided, or only the infrared ray detection camera 412 may be further provided, and a three-dimensional image may be recognized from two-dimensional images. As a result, the recognition accuracy can be further enhanced.

### (View Example of Semi-Transmissive Display)

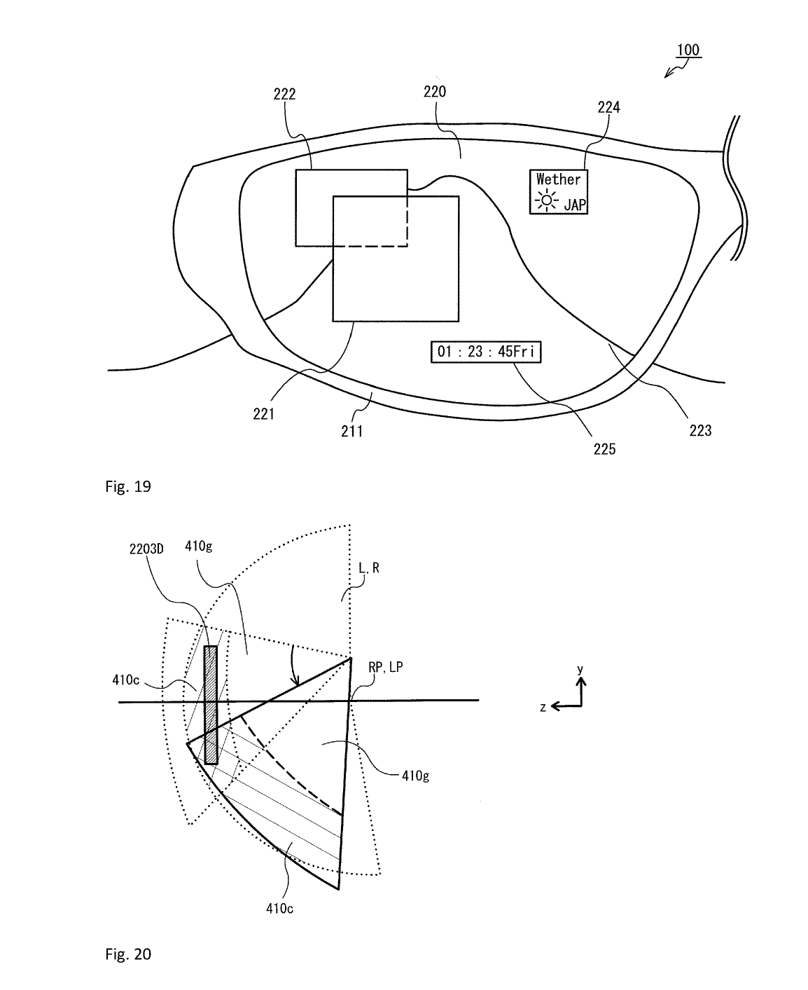

Next, FIG. 19 is a schematic diagram illustrating an example of a view of the semi-transmissive display 220 of the glasses display device 100.

As illustrated in FIG. 19, on the semi-transmissive display 220 of the glasses display device 100, an advertisement 221 is partially displayed, and a map 222 is further partially displayed. In addition, through the semi-transmissive display 220 of the glasses display device 100, scenery 223 is visually recognized. In addition, weather forecast 224 and time 225 are displayed thereon.

### (Description of Unit Adjustment Mechanism 500)

FIG. 20 is a schematic diagram illustrating another example of the manipulation region and the gesture region in the detection region. Hereinafter, only differences from FIG. 13 in FIG. 20 will be described.

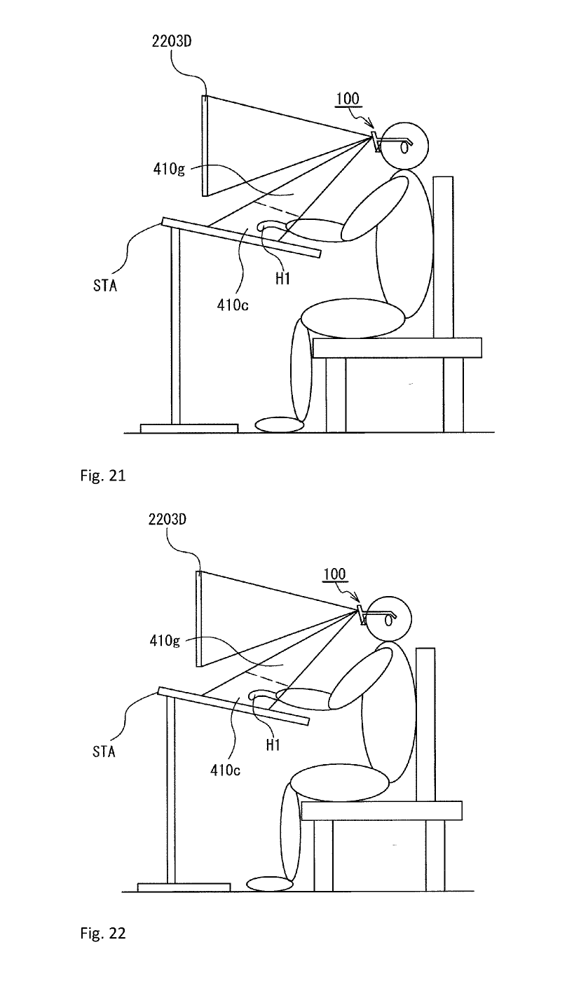

FIG. 21 and FIG. 22 are schematic diagrams illustrating a specific example of FIG. 20.

As illustrated in FIG. 20, the unit adjustment mechanism 500 is adjusted downward (direction opposite the arrow V5, see FIG. 2) from the horizontal direction. As a result, the infrared ray detection unit 410 faces downward from the horizontal direction, and the manipulation region 410c is arranged downward from the horizontal direction.

In this case, as illustrated in FIG. 21 and FIG. 22, when the user who has provided the glasses display device 100 uses a desk STA and a chair, the unit adjustment mechanism 500 is adjusted below the horizontal direction.

Here, in the adjustment of the unit adjustment mechanism 500 below the horizontal direction, the unit adjustment mechanism 500 may be operated downward by a gesture, or the operation may be set in advance according to a used application. The adjustment unit 520 may be manually adjusted to direct the unit adjustment mechanism 500 below the horizontal direction.

As illustrated in FIG. 21 and FIG. 22, since the unit adjustment mechanism 500 is adjusted below the horizontal direction, the manipulation region 410c of the infrared ray detection unit 410 can detect fingers, hands H1, or arms of the user who has provided the glasses display device 100 on the desk STA. Therefore, the manipulation region 410c of the infrared ray detection unit 410 can be positioned on the desk STA.

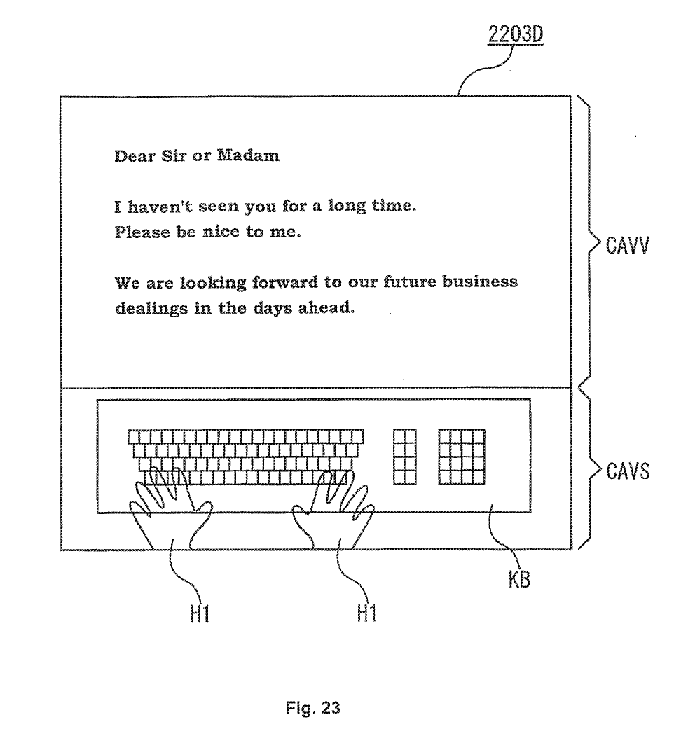

FIG. 23 is a schematic diagram illustrating an example of a view of the semi-transmissive displays 220 in the specific example illustrated in FIG. 21 and FIG. 22.

As illustrated in FIG. 23, an image CAVV of the application software and an image CAVS of the hands H1 detected by the manipulation region 410c of the infrared ray unit 410 are displayed in the virtual image display region 2203D.

In this case, the user can use the hands H1 to operate a keyboard KB displayed in the virtual image display region 2203D to input characters to the image CAVV. More specifically, the keyboard KB not arranged on the desk STA can be virtually displayed, and the keyboard KB can be operated by the hands H1.

In this case, the user can sit on the chair and put the hands H1 on the desk STA to input characters to the virtual image display region 2203D. Therefore, long-time operation can be easily performed.

Although the keyboard KB is virtual in the present embodiment, not limited thereto, the keyboard KB may be actually arranged to cause the infrared ray detection unit 410 to perform the detection.

Although the desk STA and the chair are used as illustrated in FIG. 21 and FIG. 22 in the case described in the present embodiment, not limited thereto, the hands H1 of the user can perform the operation at a low position instead of the front in the horizontal direction, and the fatigue of the hands H1 of the user can be reduced.

Note that, although the user puts the hands H1 on the desk STA to perform the operation in the present embodiment, not limited thereto, a user who cannot raise the hands H1 or the like can also perform the operation at a low position, and this is beneficial.

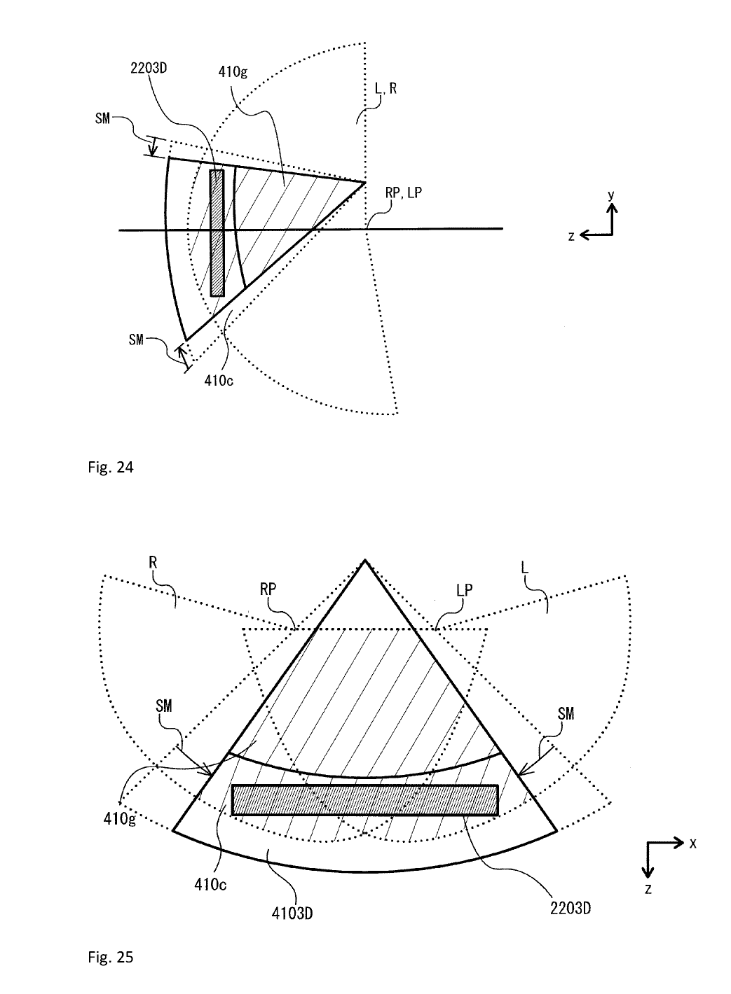

Next, FIG. 24 and FIG. 25 are schematic diagrams illustrating another example of FIG. 12 and FIG. 13.

As illustrated in FIG. 24 and FIG. 25, the unit adjustment mechanism 500 can narrow down the region range of the manipulation region 410c in directions of arrows SM. The unit adjustment mechanism 500 may physically narrow down and adjust the manipulation region 410c of the infrared ray detection unit 410 in the directions of the arrows SM or may ignore part of the detection region on software to narrow down the manipulation region 410c.

Note that, although the manipulation region 410c is narrowed down in the directions of the arrows SM in the case described in FIG. 24 and FIG. 25, not limited thereto, the manipulation region 410c may be expanded in directions opposite the arrows SM or may be biased toward one of the directions of the arrows SM.

### (Description of Display Adjustment Mechanisms 600)

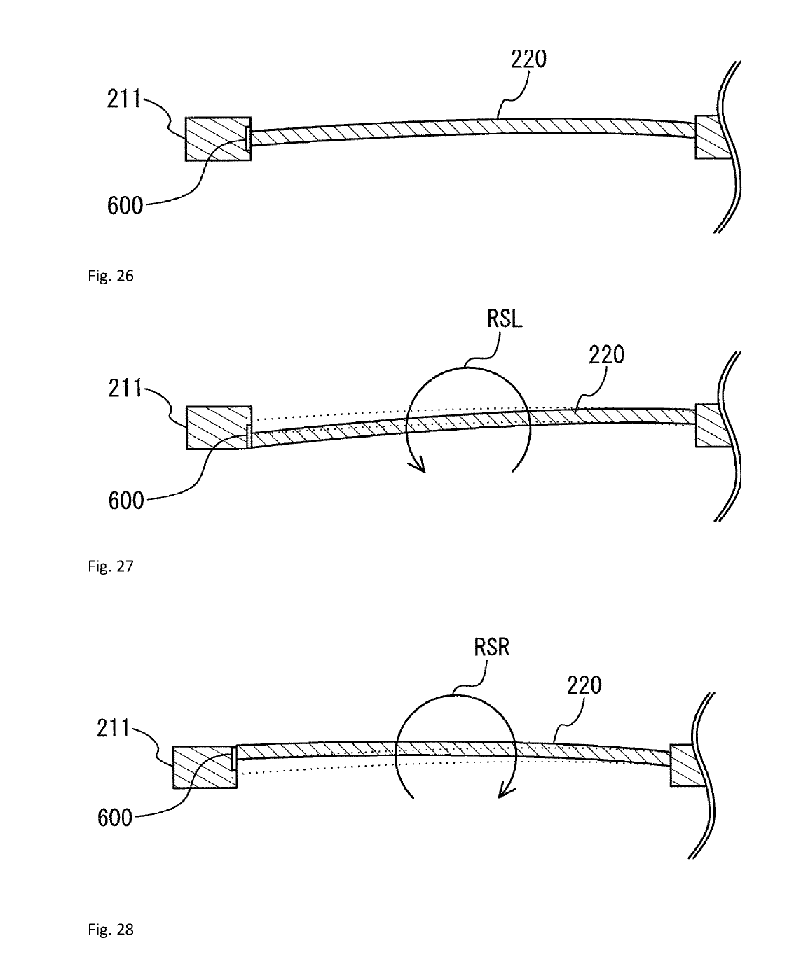

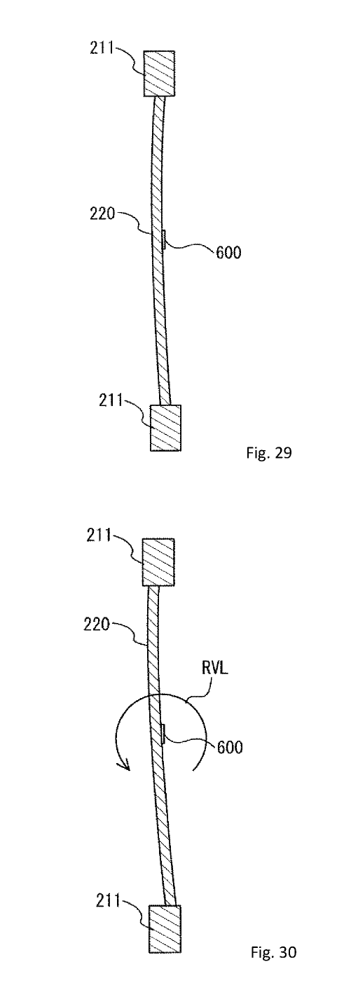

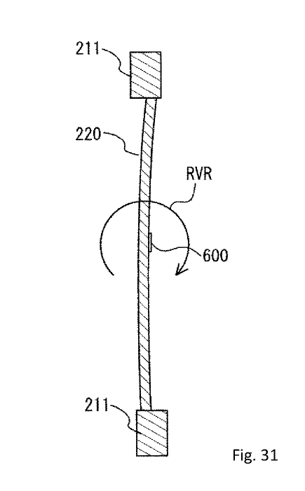

Next, FIG. 26 is a schematic cross-sectional view illustrating an A-A line cross section of FIG. 1. FIG. 27 and FIG. 28 are schematic cross-sectional views illustrating an example in which the pair of semi-transmissive displays 220 is adjusted by the display adjustment mechanisms 600 of FIG. 26. Furthermore, FIG. 29 is a schematic cross-sectional view illustrating a B-B line cross section of FIG. 2. In addition, FIG. 30 and FIG. 31 are schematic diagrams illustrating an example in which the pair of semi-transmissive displays 220 is adjusted by the display adjustment mechanisms 600 of FIG. 29.

As illustrated in FIG. 26, the pair of semi-transmissive displays 220 is attached to the display adjustment mechanisms 600. Therefore, the display adjustment mechanisms 600 adjust the angle of the pair of semi-transmissive displays 220 in a direction of an arrow RSL as illustrated in FIG. 27, and the display adjustment mechanisms 600 adjust the angle of the pair of semi-transmissive displays 220 in a direction of an arrow RSR as illustrated in FIG. 28. As a result, the user can horizontally incline the semi-transmissive displays 220.

As illustrated in FIG. 29, the pair of semi-transmissive displays 220 is attached to the display adjustment mechanisms 600. Therefore, the display adjustment mechanisms 600 adjust the angle of the pair of semi-transmissive displays 220 in a direction of an arrow RVL as illustrated in FIG. 30, and the display adjustment mechanisms 600 adjust the angle of the pair of semi-transmissive displays 220 in a direction of an arrow RVR as illustrated in FIG. 31. As a result, the user can vertically incline the semi-transmissive displays 220.

Note that the display adjustment mechanisms 600 may move one or a plurality of arrows RSL, RSR, RVL, and RVR according to a predetermined gesture of the user detected by the infrared ray detection unit 410. The display adjustment mechanisms 600 may not be automatic, and an adjustment unit 620 (see FIG. 1) including a D-pad may be able to be manually operated to make an adjustment. Alternatively, a screw, a switch, or the like may be able to be used to make an adjustment, for example.

In this case, the pair of semi-transmissive displays 220 can accurately recognize the pair of semi-transmissive displays 220 even if the user has a squint or the like. Furthermore, although the pair of semi-transmissive displays 220 has been described, it is obvious that each one of the pair of semi-transmissive displays 220 may be able to be adjusted.

The display adjustment mechanisms 600 can bring the adjustment angle closer to zero with a lapse of using time based on an instruction of the control unit 450 to obtain an advantageous effect of treating the squint.

Note that, although the user has a squint in the case described in the present embodiment, not limited thereto, the treatment can also be conducted by displaying the view after shifting the state in which the image is adjusted on the pair of semi-transmissive displays 220 to the zero state, when the user is far-sighted, has astigmatism, has amblyopia, or is color blind.

As described, the unit adjustment mechanism 500 can adjust at least one of the region width and the region position of the manipulation region 410c of the infrared ray detection unit 410. Therefore, the unit adjustment mechanism 500 can adjust the region width to adjust the region to a large width or the region to a smaller width.

Furthermore, the unit adjustment mechanism 500 can adjust the manipulation region 410c to a vertically upper region position, a vertically lower region position, a horizontally left region position, and a horizontally right region position.

Furthermore, the unit adjustment mechanism 500 can provide the manipulation region 410c below the horizontal plane. More specifically, since the unit adjustment mechanism 500 can provide the manipulation region 410c below the horizontal plane, the infrared ray detection unit 410 can measure the hands H1 that are the objects, and a view can be displayed on the semi-transmissive displays 220 even when the hands H1 are on or near the knees in the operation or when the hands H1 are on the desk in the operation. Therefore, even when the hands H1 that are the objects are below, a view can be displayed on the semi-transmissive displays 220. The degree of fatigue is low, and the operation can be easily performed for a long time.

Furthermore, the unit adjustment mechanism 500 can be manually adjusted by the adjustment unit 520. Furthermore, the unit adjustment mechanism 500 can make the adjustment based on determination by the control unit 450. For example, the unit adjustment mechanism 500 may make an adjustment if the control unit 450 determines that the hands H1 that are the objects have performed a predetermined operation or if an object is not detected by the infrared ray detection unit 410 for a predetermined time. As a result, the depth level can be automatically adjusted.

In this case, the glasses display device 100 is achieved in a small-sized and attachable mode like glasses, so that the glasses display device 100 can be easily carried. Furthermore, since the head-mounted display is small, the versatility and convenience can be enhanced.

In the present invention, the semi-transmissive display 220 corresponds to the “display device”, the hand H1 corresponds to the “object”, the infrared ray detection unit 410 corresponds to the “depth level sensor”, the control unit 450 corresponds to the “control section”, the three-dimensional space detection region 4103D corresponds to the “measurement region”, the unit adjustment mechanism 500 corresponds to the “depth level adjustment mechanism”, the adjustment unit 520 corresponds to the “first manual adjustment unit”, and the glasses display device 100 corresponds to the “I/O device”.

A preferred embodiment of the present invention has been described hereinabove, but the present invention is not limited to only the embodiment. It should be understood that various other embodiments are possible without departing from the spirit and scope of the present invention. Further, operations and effects produced by the configuration of the present invention are described in the present embodiment, but these operations and effects are given as examples, and are not intended to limit the present invention.

1. An I/O device comprising:
a display device that can generate a stereoscopic image;
a depth level sensor that measures a distance to an object;
a control section that displays a view on the display device according to the depth level sensor; and
a depth level adjustment mechanism that adjusts at least one of a region width and a region position of a measurement region of the depth level sensor.

2. The I/O device according to claim 1, wherein
the depth level adjustment mechanism makes an adjustment to provide the measurement region below a horizontal plane.

3. The I/O device according to claim 1, wherein
the depth level adjustment mechanism comprises a first manual adjustment unit that can be manually adjusted.

4. The I/O device according to claim 1, wherein
the depth level adjustment mechanism makes the adjustment based on determination by the control section.

5. The I/O device according to claim 1, wherein
the display device is a head-mounted display.

6. An I/O program comprising:
a display process of generating a stereoscopic image;
a depth level sensor process of measuring a distance to an object;
a control process of displaying a view in the display process according to the depth level sensor process; and
a depth level adjustment process of applying an adjustment process to at least one of a region width and a region position of a measurement region of the depth level sensor process.

7. The I/O program according to claim 6, wherein
an adjustment is made in the depth level adjustment process to provide the measurement region below a horizontal plane.

8. The I/O program according to claim 6, wherein
the adjustment process is executed in the depth level adjustment process based on determination in the control process.

9. An I/O method comprising:
a display step of generating a stereoscopic image;
a depth level sensor step of measuring a distance to an object;
a control step of displaying a view in the display step according to the depth level sensor step; and
a depth level adjustment step of adjusting at least one of a region width and a region position of a measurement region of the depth level sensor step.

10. The I/O method according to claim 9, wherein
an adjustment is made in the depth level adjustment step to provide the measurement region below a horizontal plane.

11. The I/O method according to claim 9, wherein
the adjustment is made in the depth level adjustment step based on determination in the control step.
